(19) United States
(12) Patent Application Publication
(10) Pub. No.: US 2019/0057351 A1
(43) Pub. Date: Feb. 21, 2019

(54) SYSTEM AND METHOD FOR MANAGEMENT OF GOODS DELIVERY

(71) Applicant: Dragontail Systems Ltd., Ramat Gan (IL)

(72) Inventor: Guy BRANDWINE, Shaarey Tikva (IL)

(73) Assignee: Dragontail Systems Ltd., Ramat Gan (IL)

(21) Appl. No.: 15/678,597

(22) Filed: Aug. 16, 2017

(51) Int. Cl. G06Q 10/08; G06Q 30/02

(52) U.S. Cl. CPC G06Q 10/08355; G06Q 30/0282

(57) ABSTRACT

Systems and methods of managing delivery of goods, including receiving at least one order of goods to be delivered, receiving a time limit for completing the delivery of the at least one order, determining a set of available couriers to perform the delivery within the time limit, and assigning the delivery to a courier from the set of available couriers based on at least one delivery assignment rule, wherein the at least one delivery assignment rule is at least one of: minimum deliveries per time interval, maximal distance per time interval, minimum rest time between deliveries, balanced distribution of deliveries between available couriers, and balanced distribution of distance to complete the delivery between available couriers.

### FIELD OF THE INVENTION

The present invention relates to delivery of goods. More particularly, the present invention relates to systems and methods for management of goods delivery, and couriers thereof.

### BACKGROUND OF THE INVENTION

Facilities that provide goods for delivery, such as restaurants, flower shops, etc., have a predefined set of couriers that deliver the goods to different locations. When a delivery order arrives, a courier associated with the facility (receiving the order) is selected to carry out the delivery. Usually, an available courier closest to the facility is selected.

There are specific time periods (e.g., rush hours) with increased number of received orders. However, orders are not evenly distributed along operation hours of a facility, and the time required in order to complete a delivery (e.g., time from receiving an order till the courier is available to handle another delivery) may differ from one order to another. Thus, there is a problem planning courier shifts and maintaining a proper work load to all couriers (e.g., allowing sufficient rest time between deliveries, evenly distributing deliveries between couriers, etc.). In a shop chain, such as a fast food chain, the problem may be even more acute, as at a given time, in one branch, there may be idleness of some or all of the couriers, while, in another branch, there may be a need for additional couriers in order to comply with all orders in time.

### SUMMARY OF THE INVENTION

There is thus provided, in accordance with some embodiments of the invention, a method of managing delivery of goods, the method including receiving, by a communication module, at least one order of goods to be delivered; receiving, by a processor coupled to the communication module, a time limit for completing the delivery of the at least one order; determining, by the processor, a set of available couriers to perform the delivery within the time limit; and assigning, by the processor, the delivery to a courier from the set of available couriers based on at least one delivery assignment rule. In some embodiments, the at least one delivery assignment rule may be at least one of: minimum deliveries per time interval, maximal distance per time interval, minimum rest time between deliveries, balanced distribution of deliveries between available couriers, and balanced distribution of distance to complete the delivery between available couriers.

In some embodiments, determining the set of available couriers may include checking the availability of couriers from at least one of a first group of couriers associated with a first facility where the goods are collected for delivery, a second group of couriers associated with a second facility associated with the first facility, and a third group of reserve couriers. In some embodiments, assigning the delivery to a courier from the second group comprises determining that couriers from the first group are not available. In some embodiments, assigning the delivery a courier from the third group comprises determining that couriers from the first group and the second group are not available.

In some embodiments, the method may further include registering, by the processor, a plurality of potential couriers to the third group; determining, by the processor, an availability status of each courier in the third group; sending, by the communication module, at least one delivery offer to available couriers from the third group; receiving, by the communication module, a request to carry out the delivery by at least one available courier from the third group; calculating, by the processor, expected delivery time for available couriers in the third group that requested to carry out the delivery; and assigning, by the processor, the delivery to a courier with the calculated expected delivery time within the received time limit.

In some embodiments, the at least one delivery assignment rule may include at least one of weight of goods to be delivered, amount of goods to be delivered, weather conditions and preparation time for goods to be delivered. In some embodiments, the at least one delivery assignment rule may include at least one of type of delivery, type of vehicle for delivery, and courier characteristics.

In some embodiments, preparation time may be calculated for each received order, in accordance with the received amount of goods to be delivered. In some embodiments, delivery time may be calculated for each received order, in accordance with at least one of the location of assigned courier, calculated preparation time, time of courier arrival at preparation facility, and distance to complete the delivery. In some embodiments, delivery time may be calculated for each received order for at least two preparation facilities, and wherein the courier is assigned for delivery from the preparation facility with the shortest delivery time. In some embodiments, a delivery rank may be assigned for each courier, wherein the delivery rank is based on at least one of delivery time, customer reviews and the preparation facility.

There is thus provided, in accordance with some embodiments of the invention, a system for management of goods delivery by a set of couriers, with each courier having a mobile device, the system including a processor configured to receive at least one order of goods to be delivered and receive a time limit for completing the delivery of the at least one order, and a communication module coupled to the processor and configured to communicate with at least one mobile device, wherein the processor is further configured to determine a set of available couriers to perform the delivery within the time limit and assign the delivery to a courier from the set of available couriers based on at least one delivery assignment rule. In some embodiments, the at least one delivery assignment rule may be at least one of: minimum deliveries per time interval, maximal distance per time interval, minimum rest time between deliveries, balanced distribution of deliveries between available couriers, and balanced distribution of distance to complete the delivery between available couriers.

In some embodiments, the processor may be configured to check availability of couriers from at least one of a first group of couriers associated with a first facility where the goods are collected for delivery, a second group of couriers associated with a second facility associated with the first facility, and a third group of reserve couriers. In some embodiments, the processor may be configured to assign the delivery to a courier from the second group comprises determining that couriers from the first group are not available.

In some embodiments, the processor may be configured to assign the delivery to a courier from the third group comprises determining that couriers from the first group and the second group are not available. In some embodiments, the processor may be configured to register a plurality of potential couriers to the third group and determine an availability status of each courier in the third group. In some embodiments, the at least one delivery assignment rule may include at least one of weight of goods to be delivered, amount of goods to be delivered, weather conditions, preparation time for goods to be delivered, type of delivery, type of vehicle for delivery, and courier characteristics.

In some embodiments, the processor may be configured to calculate delivery time for each received order, in accordance with at least one of the location of assigned courier, calculated preparation time, and distance to complete the delivery. In some embodiments, the processor may be configured to calculate delivery time for each received order for at least two preparation facilities, and wherein the courier is assigned for delivery from the preparation facility with the shortest delivery time. In some embodiments, the processor may be configured to assign a delivery rank for each courier, wherein the delivery rank is based on at least one of delivery time, customer reviews and the preparation facility.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a block diagram of an examplary computing device, according to some embodiments of the invention;

FIG. 2 shows a block diagram of a delivery management system, according to some embodiments of the invention;

FIG. 3 shows a flowchart for a method of courier selection, according to some embodiments of the invention; and

FIG. 4 shows a flowchart for a method of managing delivery of goods, according to some embodiments of the invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently.

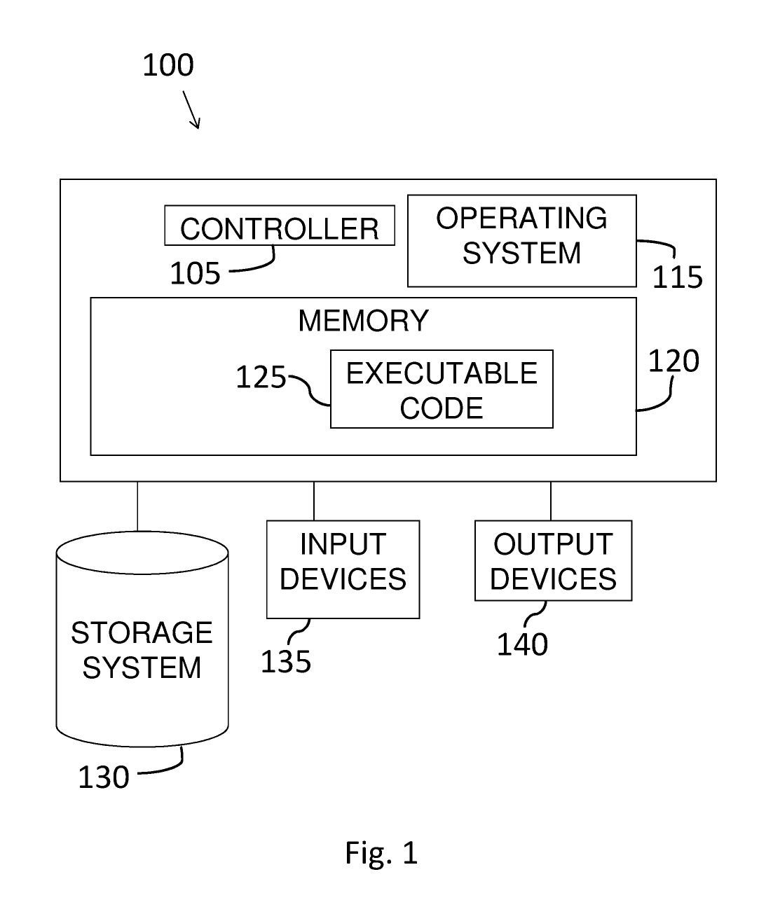

Reference is made to FIG. 1, which shows a block diagram of an examplary computing device, according to some embodiments of the invention. A device 100 may include a controller 105 that may be, for example, a central processing unit processor (CPU), a chip or any suitable computing or computational device, an operating system 115, a memory 120, executable code 125, a storage system 130 that may include input devices 135 and output devices 140. Controller 105 (or one or more controllers or processors, possibly across multiple units or devices) may be configured to carry out methods described herein, and/or to execute or act as the various modules, units, etc. More than one computing device 100 may be included in, and one or more computing devices 100 may act as the components of, a system according to embodiments of the invention.

Operating system 115 may be or may include any code segment (e.g., one similar to executable code 125 described herein) designed and/or configured to perform tasks involving coordination, scheduling, arbitration, supervising, controlling or otherwise managing operation of computing device 100, for example, scheduling execution of software programs or tasks or enabling software programs or other modules or units to communicate. Operating system 115 may be a commercial operating system. It will be noted that an operating system 115 may be an optional component, e.g., in some embodiments, a system may include a computing device that does not require or include an operating system 115.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may be a computer or processor non-transitory readable medium, or a computer non-transitory storage medium, e.g., a RAM.

Executable code 125 may be any executable code, e.g., an application, a program, a process, task or script. Executable code 125 may be executed by controller 105 possibly under control of operating system 115. Although, for the sake of clarity, a single item of executable code 125 is shown in FIG. 1, a system according to some embodiments of the invention may include a plurality of executable code segments similar to executable code 125 that may be loaded into memory 120 and cause controller 105 to carry out methods described herein.

Storage system 130 may be or may include, for example, a flash memory, a hard disk drive, a universal serial bus (USB) device or other suitable removable and/or fixed storage unit. Content may be stored in storage system 130 and may be loaded from storage system 130 into memory 120 where it may be processed by controller 105. In some embodiments, some of the components shown in FIG. 1 may be omitted. For example, memory 120 may be a non-volatile memory having the storage capacity of storage system 130. Accordingly, although shown as a separate component, storage system 130 may be embedded or included in memory 120.

Input devices 135 may be or may include any suitable input devices, components or systems, e.g., a detachable keyboard or keypad, a mouse and the like. Output devices 140 may include one or more (possibly detachable) displays or monitors, speakers and/or any other suitable output devices. Any applicable input/output (I/O) devices may be connected to computing device 100 as shown by blocks 135 and 140. For example, a wired or wireless network interface card (NIC), a universal serial bus (USB) device or external hard drive may be included in input devices 135 and/or output devices 140. It will be recognized that any suitable number of input devices 135 and output device 140 may be operatively connected to computing device 100 as shown by blocks 135 and 140. For example, input devices 135 and output devices 140 may be used by a technician or engineer in order to connect to a computing device 100, update software and the like.

Some embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, a storage medium such as memory 120, computer-executable instructions such as executable code 125 and a controller such as controller 105.

The storage medium may include, but is not limited to, any type of disk including magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

Some embodiments of the invention may include components such as, but not limited to, a plurality of central processing units (CPU) or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components. In some embodiments, a system may include or may be, for example, a personal computer, a desktop computer, a mobile computer, a laptop computer, a notebook computer, a terminal, a workstation, a server computer, a Personal Digital Assistant (PDA) device, a tablet computer, a network device, or any other suitable computing device.

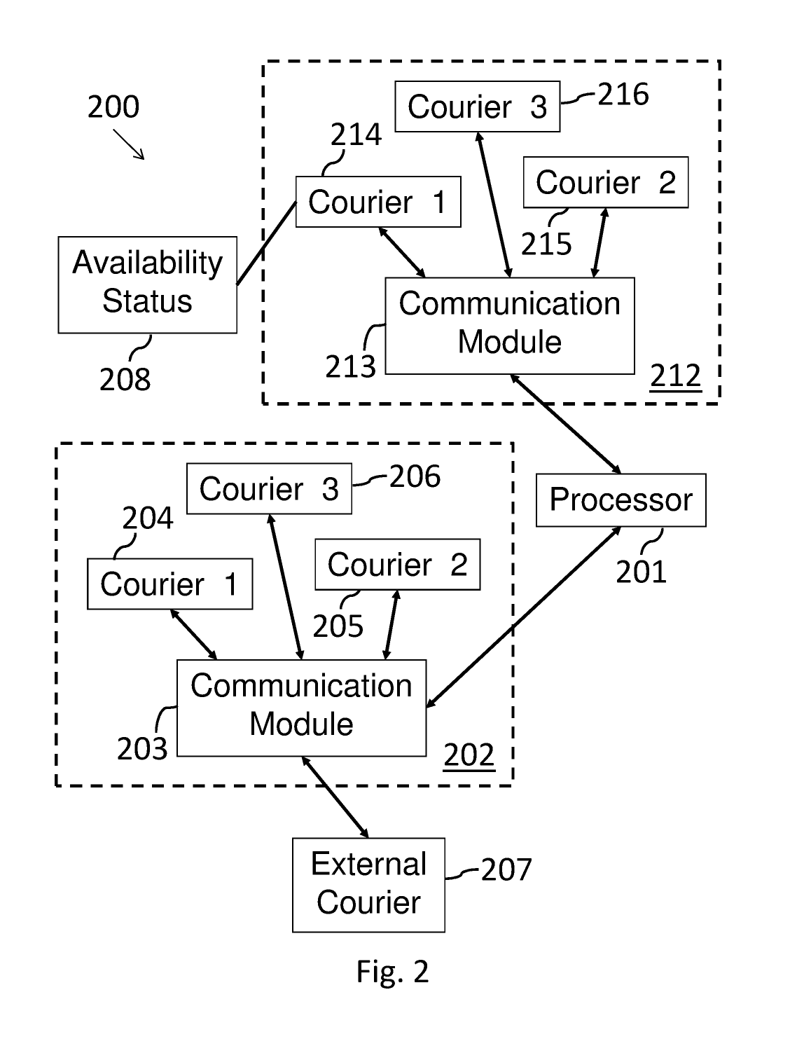

Reference is made to FIG. 2, which shows a block diagram of a delivery management system 200, according to some embodiments of the invention. The delivery management system 200 may include at least one processor 201 (e.g., such as controller 105 shown in FIG. 1) configured to execute code to manage goods deliveries with at least one courier. In some embodiments, the directions of arrows may indicate the direction of information flow.

Processor 201 may be coupled to a first facility 202 from which goods are to be delivered (e.g., a pizzeria), via at least one communication module 203 coupled to the at least one processor 201. The at least one communication module 203 may be coupled to a first group of couriers 204, 205, 206 each via a mobile communication device (e.g., smartphone) capable of determining location of the courier, with each courier in the first group associated with the first facility 202.

In some embodiments, processor 201 may be further coupled to a second facility 212 associated with the first facility 202 (e.g., another branch of the pizzeria), via at least one communication module 213 coupled to the at least one processor 201. The processor 201 may be thus coupled to a second group of couriers 214, 215, 216 each via a mobile communication device (e.g., smartphone) capable of determining location of the courier, with each courier in the second group associated with the second facility 212 via the at least one communication module 213. In some embodiments, in case that couriers 204, 205, 206 in the first group are not available to carry out a delivery in a received time limit (e.g., 30 minutes) at least one available courier 214, 215, 216 from the second group may be automatically assigned to the delivery by the processor 201. In some embodiments, first facility 202 and second facility 212 may be in an agreement for courier sharing so that orders for delivery received by the second facility 212 may be similarly carried out by a courier 204, 205, 206 from the first group associated with the first facility 202.

According to some embodiments, first facility 202 may be coupled to at least one external courier 207 (e.g., via at least one communication module 203) from a third group, where external courier 207 may not be associated with the first facility 202. For example, a pizzeria 202 having two regular couriers 204, 205 communicating via their mobile phones may allow a central processor 201 (e.g., coupled to the communication module 203 of the pizzeria 202) to continuously determine the location of each courier 204, 205. During rush hours, the two regular couriers 204, 205 may be assigned to deliver pizzas according to availability and proximity to the pizzeria 202, while an external courier 207 may be assigned for a delivery if both couriers 204, 205 are not available. In some embodiments, each courier may register to processor 201 with at least one courier detail such as type of vehicle, preferred working hours, preferred payment method, preferred delivery distance, and potential capacity of goods to be delivered.

In some embodiments, a plurality of potential external couriers 207 may be initially registered with processor 201 to the third group. Processor 201 may determine an availability status of each courier in the third group and send at least one delivery offer (e.g., via the communication module 203) to available couriers from the third group. A request to carry out the delivery by at least one available courier from the third group may be received by processor 201 (e.g., via the communication module 203), such that processor 201 may calculate expected delivery time for each available courier in the third group that requested to carry out the delivery. The processor 201 may then assign the delivery to a courier 207 with the calculated expected delivery time within the received time limit (e.g., under 30 minutes). For example, a vehicle owner in the vicinity of a flower shop 202 may register (e.g., via a dedicated platform) to the third group as an external courier 207 and receive a delivery offer when an availability status is determined. If the vehicle owner chooses to accept the offer (e.g., via a dedicated platform such as a mobile application), the processor 201 may receive a request to carry out the delivery and calculate corresponding expected delivery time. The calculated expected delivery time may be based on at least one of location of the courier, location of the facility with the goods to be delivered, preparation time of the goods, location of delivery destination, weather conditions and current traffic. Processor 201 may assign the delivery to the external courier 207 (e.g., instead of couriers in the first group) if the calculated expected delivery time is within the received time limit (e.g., under an hour). In some embodiments, the preparation time may correspond to availability of couriers to carry out the delivery. For example, a pizzeria 202 may commence preparation of a pizza order only when a courier 204, 215, 207 has been assigned by processor 201.

According to some embodiments, processor 201 may apply machine learning methods to optimize delivery assignments to couriers. For example, processor 201 may store and analyze working hours for each courier, area of delivery, type of vehicle, average number of deliveries, etc.

It should be appreciated that while two facilities are shown in FIG. 2, the same may similarly apply to any number of facilities and/or any number of couriers and/or type of couriers.

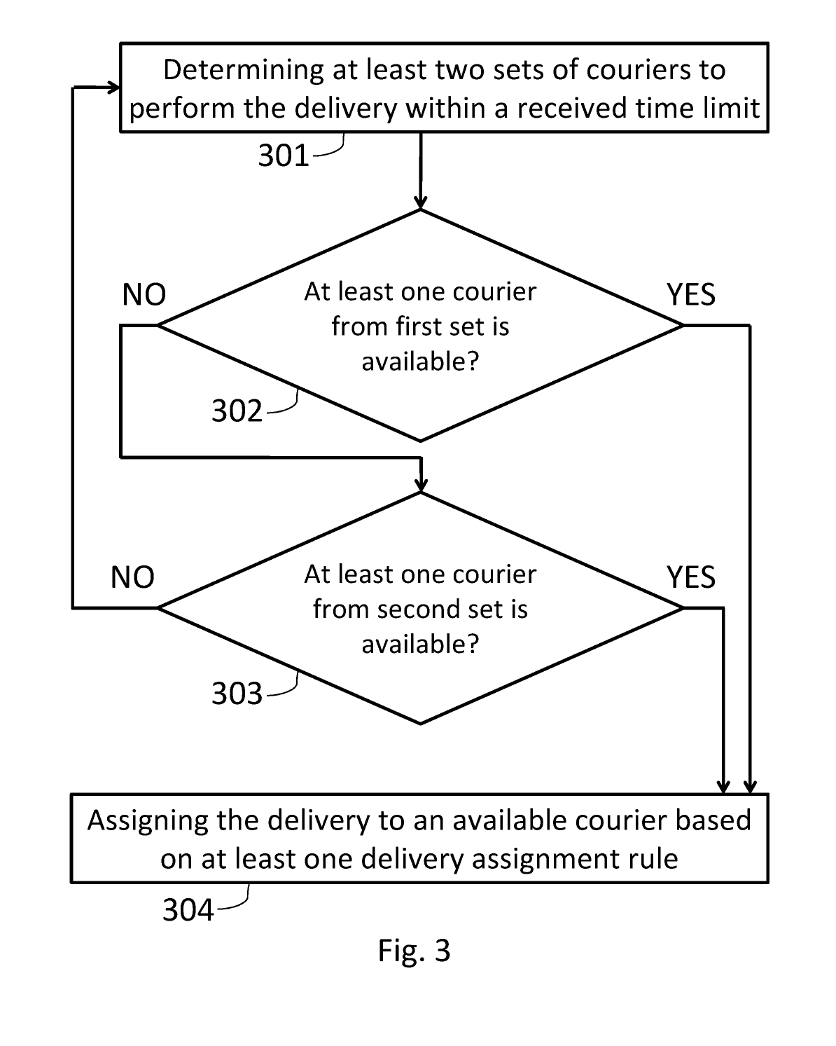

Reference is made to FIG. 3, which shows a flowchart for a method of courier selection, according to some embodiments of the invention. Processor 201 may determine 301 at least two sets of couriers to perform the delivery within a received time limit, using at least one communication module 203, 213. In some embodiments, the sets of couriers may be selected from the first group of couriers 204, 205, 206 associated with the first facility 202, from the second group of couriers 214, 215, 216 associated with the second facility 212 and/or from the third group of external couriers 207.

In some embodiments, processor 201 may select a courier between a first set (e.g., of first group of couriers 204, 205, 206) and a second set (e.g., of external couriers 207). In some embodiments, processor 201 may check 302 if at least one courier from the first set is available for delivery. In case that at least one courier from the first set is available for delivery (within the received time limit), processor 201 may assign 304 the delivery to an available courier, from the first set, based on at least one delivery rule. In some embodiments, the at least one delivery assignment rule may be at least one of: minimum deliveries per time interval, maximal distance per time interval, minimum rest time between deliveries, balanced distribution of deliveries between available couriers, time for courier to arrive at the preparation facility, and balanced distribution of distance to complete the delivery between available couriers. In some embodiments, the at least one delivery assignment rule may include courier characteristics to be determined by processor 201 and/or by customer reviews. For example, courier characteristics may include at least one of courier delivering goods on determined time, conditions of delivered goods delivered by the courier, general availability of the courier, and averaged delivery time.

In case that no courier from the first set is available for delivery (within the received time limit), processor 201 may check 303 if at least one courier from the second set is available for delivery. In case that at least one courier from the second set is available for delivery (within the received time limit), processor 201 may assign 304 the delivery to an available courier, from the second set, based on the at least one delivery rule. In some embodiments, a courier may decide to cancel a delivery for some reason, so processor 201 may return to determine 301 at least two sets of couriers to perform the delivery within the received time limit (e.g., remove the courier canceling the order from the at least one set of couriers).

In case that no courier from the second set is available for delivery (within the received time limit), processor 201 may return to determine 301 at least two sets of couriers to perform the delivery within the received time limit (e.g., add couriers to at least one set of couriers). In some embodiments, in case that no courier from the second set including external couriers 207 is available for delivery (within the received time limit), processor 201 may update the delivery offer (e.g., modify payment value for the delivery). It should be appreciated that, while a first set and a second set are shown in FIG. 3, the same method may apply to any number of sets.

For example, the processor 201 may determine 301 the first set as the first group of couriers 204, 205, 206 associated with a first pizzeria 202, the second set as the second group of couriers 214, 215, 216 associated with a second pizzeria 212, and the third set as the third group of external couriers 207. Processor 201 may receive an order for a pizza delivery (e.g., via the communication module) and a time limit (e.g., 30 minutes), and check 302 if at least one courier from the first set (from the first group) is available for delivery within the time limit and based on the minimum deliveries per time interval as the delivery rule. If all couriers in the first set carried out at least the minimum number of deliveries per time interval (e.g., twenty deliveries in a 12-hour shift) and none of them is currently available to carry out the delivery within the time limit, processor 201 may check 303 if at least one courier from the second set (from the second group) is available for delivery, for instance if the first pizzeria 202 and the second pizzeria 212 are in an agreement to share couriers. If all couriers in the second set carried out at least the minimum number of deliveries per time interval and none of them is currently available to carry out the delivery from the first pizzeria within the time limit, processor 201 may check if at least one courier from the third set (from the third group) is available for delivery. For instance, processor 201 may send an order to all external couriers registered to the third group and receive a request from at least one available courier to be assigned 304 for the delivery.

In some embodiments, facilities in an agreement to share couriers may have to also assign couriers to deliver goods from a different facility from where the order was received. For example, three branches of the same pizzeria in the same city may be in agreement to share couriers, and the processor may assign an available courier from the second pizzeria to carry out a delivery order received in the first pizzeria, where the pizza to be delivered may be provided at the second pizzeria.

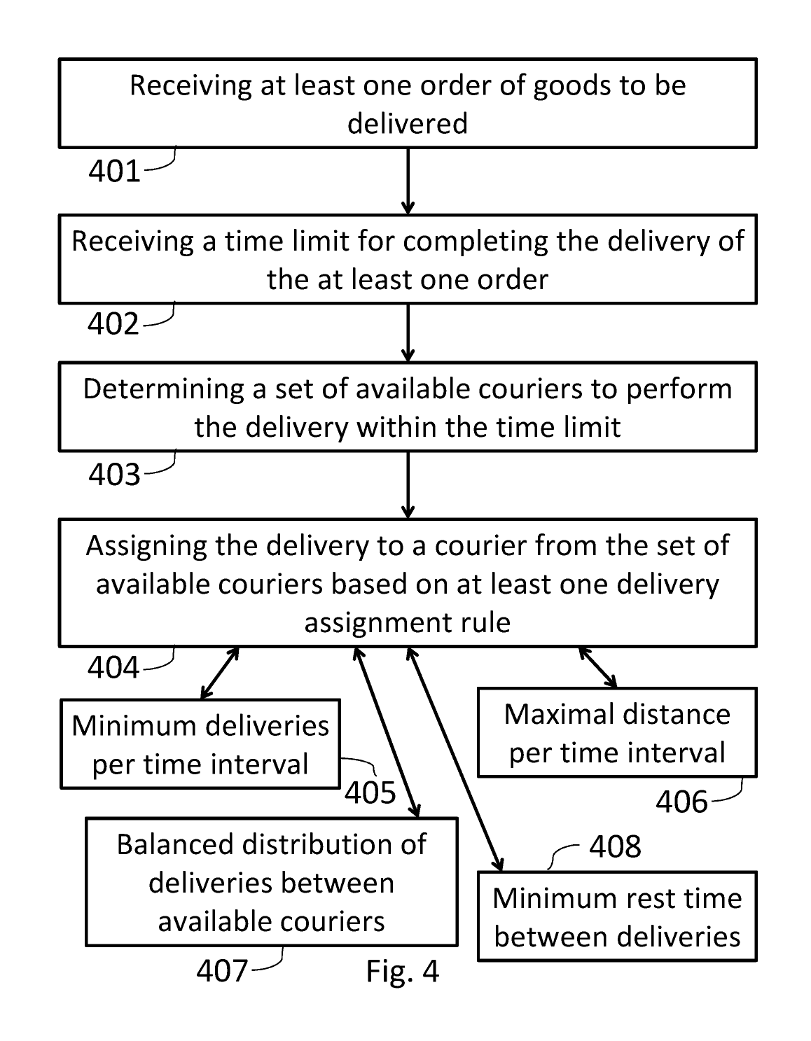

Reference is made to FIG. 4, which shows a flowchart of a method of managing delivery of goods, according to some embodiments of the invention. The communication module 203 may receive 401 at least one order of goods to be delivered. The processor 201 may receive 402 a time limit for completing the delivery of the at least one order.

In some embodiments, processor 201 may determine 403 a set of available couriers to perform the delivery within the time limit. In some embodiments, processor 201 may assign 404 the delivery to a courier from the set of available couriers based on at least one delivery assignment rule. In some embodiments, the at least one delivery assignment rule may be at least one of: minimum deliveries per time interval, maximal distance per time interval, minimum rest time between deliveries, balanced distribution of deliveries between available couriers, and balanced distribution of distance to complete the delivery between available couriers.

Unless explicitly stated, the method embodiments described herein are not constrained to a particular order in time or chronological sequence. Additionally, some of the described method elements may be skipped, or they may be repeated, during a sequence of operations of a method.

Various embodiments have been presented. Each of these embodiments may of course include features from other embodiments presented, and embodiments not specifically described may include various features described herein.

1. A method of managing delivery of goods, the method comprising:
receiving, by a communication module, at least one order of goods to be delivered;
receiving, by a processor coupled to the communication module, a time limit for completing the delivery of the at least one order;
determining, by the processor, a set of available couriers to perform the delivery within the time limit; and
assigning, by the processor, the delivery to a courier from the set of available couriers based on at least one delivery assignment rule,
wherein the at least one delivery assignment rule is at least one of: minimum deliveries per time interval, maximal distance per time interval, minimum rest time between deliveries, balanced distribution of deliveries between available couriers, and balanced distribution of distance to complete the delivery between available couriers.

2. The method of claim 1, wherein determining the set of available couriers comprises checking availability of couriers from at least one of a first group of couriers associated with a first facility where the goods are collected for delivery, a second group of couriers associated with a second facility associated with the first facility, and a third group of reserve couriers.

3. The method of claim 2, wherein assigning, by the processor, the delivery to a courier from the second group comprises determining that couriers from the first group are not available.

4. The method of claim 2, wherein assigning, by the processor, the delivery to a courier from the third group comprises determining that couriers from the first group and the second group are not available.

5. The method of claim 2, further comprising:
registering, by the processor, a plurality of potential couriers to the third group;
determining, by the processor, an availability status of each courier in the third group;
sending, by the communication module, at least one delivery offer to available couriers from the third group;
receiving, by the communication module, a request to carry out the delivery by at least one available courier from the third group;
calculating, by the processor, expected delivery time for available couriers in the third group that requested to carry out the delivery; and
assigning, by the processor, the delivery to a courier with the calculated expected delivery time within the received time limit.

6. The method of claim 1, wherein the at least one delivery assignment rule comprises at least one of weight of goods to be delivered, amount of goods to be delivered, weather conditions and preparation time for goods to be delivered.

7. The method of claim 1, wherein the at least one delivery assignment rule comprises at least one of type of delivery, type of vehicle for delivery, and courier characteristics.

8. The method of claim 1, further comprising calculating, by the processor, preparation time for each received order, in accordance with the received amount of goods to be delivered.

9. The method of claim 8, further comprising calculating, by the processor, delivery time for each received order, in accordance with at least one of the location of assigned courier, calculated preparation time, time of courier arrival at preparation facility, and distance to complete the delivery.

10. The method of claim 1, further comprising calculating, by the processor, delivery time for each received order for at least two preparation facilities, and wherein the courier is assigned for delivery from the preparation facility with the shortest delivery time.

11. The method of claim 1, further comprising assigning, by the processor, a delivery rank for each courier, wherein the delivery rank is based on at least one of delivery time, customer reviews and the preparation facility.

12. A system for management of goods delivery by a set of couriers with each courier having a mobile device, the system comprising:
a processor, configured to receive at least one order of goods to be delivered and receive a time limit for completing the delivery of the at least one order; and
a communication module, coupled to the processor and configured to communicate with at least one mobile device, wherein the processor is further configured to determine a set of available couriers to perform the delivery within the time limit and assign the delivery to a courier from the set of available couriers based on at least one delivery assignment rule,
wherein the at least one delivery assignment rule is at least one of: minimum deliveries per time interval, maximal distance per time interval, minimum rest time between deliveries, balanced distribution of deliveries between available couriers, and balanced distribution of distance to complete the delivery between available couriers.

13. The system of claim 12, wherein the processor is configured to check availability of couriers from at least one of a first group of couriers associated with a first facility where the goods are collected for delivery, a second group of couriers associated with a second facility associated with the first facility, and a third group of reserve couriers.

14. The system of claim 13, wherein the processor is configured to assign the delivery to a courier from the second group upon determination that couriers from the first group are not available.

15. The system of claim 13, wherein the processor is configured to assign the delivery to a courier from the third group upon determination that couriers from the first group and the second group are not available.

16. The system of claim 12, wherein the processor is configured to register a plurality of potential couriers to the third group and determine an availability status of each courier in the third group.

17. The system of claim 12, wherein the at least one delivery assignment rule comprises at least one of weight of goods to be delivered, amount of goods to be delivered, weather conditions, preparation time for goods to be delivered, type of delivery, type of vehicle for delivery, and courier characteristics.

18. The system of claim 12, wherein the processor is configured to calculate delivery time for each received order, in accordance with at least one of the location of assigned courier, calculated preparation time, and distance to complete the delivery.

19. The system of claim 12, wherein the processor is configured to calculate delivery time for each received order for at least two preparation facilities, and wherein the courier is assigned for delivery from the preparation facility with the shortest delivery time.

20. The system of claim 12, wherein the processor is configured to assign a delivery rank for each courier, wherein the delivery rank is based on at least one of delivery time, customer reviews and the preparation facility.
